(19) United States
(12) Patent Application Publication
(10) Pub. No.: US 2016/0279794 A1
(43) Pub. Date: Sep. 29, 2016

(54) ROBOT CONTROLLER CAPABLE OF PERFORMING FAULT DIAGNOSIS OF ROBOT

(71) Applicant: FANUC CORPORATION, Yamanashi (JP)

(72) Inventors: Shougo INAGAKI, Yamanashi (JP); Soichi ARITA, Yamanashi (JP); Hiromitsu TAKAHASHI, Yamanashi (JP)

(21) Appl. No.: 15/068,642

(22) Filed: Mar. 14, 2016

(30) Foreign Application Priority Data
Mar. 24, 2015 (JP) 2015-060887

(51) Int. Cl. B25J 9/16

(52) U.S. Cl. CPC B25J 9/1674; Y10S 901/46; Y10S 901/49

(57) ABSTRACT

A robot controller includes a first time-series data obtaining part for obtaining first data used for fault diagnosis in time series and store the first data as first time-series data, a second time-series data obtaining part for obtaining second data used for extraction of the first data which is used for the fault diagnosis in time series and store the second data as second time-series data, a time specification part for specifying extraction time of the first data used for the fault diagnosis based on the second time-series data, a data extraction part for extracting the first data corresponding to the extraction time, and a diagnosis performing part for performing the fault diagnosis of the robot based on the first data extracted by the data extraction part.

### BACKGROUND ART

1. Technical Field

The present invention relates to a robot controller for controlling a robot.

2. Description of the Related Art

In a production line, an Industrial robot is used with a number of other robots or machines. Thus, even when only one robot fails to operate properly, the whole production line may be terminated. It often takes an enormous time to replace a mechanism part of the robot, such as a speed reducer. If the production is halted for a long period of time due to a failure of the robot, it could lead to significant damages. Therefore, there is a need for means for detecting the malfunction of the robot early to prevent the halt of the production line.

JP S63-123105 A discloses a fault prediction and diagnosis method for a robot of a teaching-playback type. According to the related art, a robot which can properly operate is operated in advance in accordance with a referential operating pattern to obtain referential data corresponding to the referential operating pattern. After the robot is operated for a certain period of time, the robot is again operated in accordance with the referential operating pattern to obtain data, which is used for comparison with the referential data in order to predict or diagnose a malfunction of the robot.

JP 2014-232450 A discloses a data processing device used to determine whether or not a robot is subject to aged deterioration by comparing outputs (servo data) of the robot in response to substantially the same input condition (position command). According to the related art, the data is extracted from a large volume of data for the comparison, based on the degrees of similarity in relation to the template corresponding to a referential operation.

However, according to the related art described in JP S63-123105 A, it is necessary to periodically perform the referential operation which is irrelevant to intended operations during a production process, resulting in decreased efficiency. In addition, if surrounding conditions of the robot change, the same referential operation may not be always implemented. In the related art described in JP 2014-232450 A, it is complicated and time-consuming for a user to prepare a template, resulting in increased cost.

Therefore, there is a need for a robot controller which allows a fault diagnosis of a robot to be performed without a preparation in advance and without interrupting a production process.

### SUMMARY OF THE INVENTION

According to a first aspect of the present invention, there is provided a robot controller capable of performing fault diagnosis of a robot, the robot controller comprising: a first time-series data obtaining part configured to obtain first data used for the fault diagnosis in time series and store the first data as first time-series data; a second time-series data obtaining part configured to obtain second data used for extraction of the first data which is used for the fault diagnosis in time series and store the second data as second time-series data; a time specification part configured to specify extraction time of the first data used for the fault diagnosis, based on the second time-series data; a data extraction part configured to extract the first data corresponding to the extraction time specified by the time specification part, from the first time-series data; and a diagnosis performing part configured to perform the fault diagnosis of the robot based on the first data extracted by the data extraction part.

According to a second aspect of the present invention, there is provided a robot controller according to the first aspect, wherein the second data is speed information calculated from encoder output.

According to a third aspect of the present invention, there is provided a robot controller according to the first aspect, wherein the second data is a speed command calculated by robot software.

According to a fourth aspect of the present invention, there is provided a robot controller according to the first aspect, wherein the second data is acceleration information calculated from encoder output.

According to a fifth aspect of the present invention, there is provided a robot controller according to the first aspect, wherein the second data is an acceleration command calculated by robot software.

According to a sixth aspect of the present invention, there is provided a robot controller according to any one of the first to fifth aspects, wherein the first data is torque obtained by a torque sensor attached to the robot.

According to a seventh aspect of the present invention, there is provided a robot controller according to any one of the first to fifth aspects, wherein the first data is a torque command calculated by robot software.

According to an eighth aspect of the present invention, there is provided a robot controller according to any one of the first to fifth aspects, wherein the first data is disturbance torque calculated by robot software.

According to a ninth aspect of the present invention, there is provided a robot controller according to any one of the first to third and sixth to eighth aspects, wherein the time specification part is configured to specify a time period during which speed of the robot remains constant as the extraction time, and wherein the diagnosis performing part is configured to perform the fault diagnosis of the robot in accordance with a frequency analysis of the first data extracted.

According to a tenth aspect of the present invention, there is provided a robot controller according to any one of the first to third and sixth to eighth aspects, wherein the time specification part is configured to specify a time period during which speed of the robot is within a certain range as the extraction time, and wherein the diagnosis performing part is configured to perform the fault diagnosis of the robot in accordance with a frequency analysis of the first data extracted.

According to an eleventh aspect of the present invention, there is provided a robot controller according to any one of the first, and fourth to eighth aspects, wherein the first data is torque generated in the torque, wherein the time specification part is configured to specify a time period during which acceleration of the robot is a certain amount as the extraction time, and wherein the diagnosis performing part is configured to perform the fault diagnosis of the robot based on the torque.

According to a twelfth aspect of the present invention, there is provided a robot controller according to any one of the first to eleventh aspects, wherein the first time-series data and the second time-series data are the same time-series data.

These and other objects, features and advantages of the present invention will become more apparent in light of the detailed description of exemplary embodiments thereof as illustrated in the drawings.

### BRIEF DESCRIPTION OF THE DRAWINGS

FIG. 1 is a functional block diagram of a robot controller according to one embodiment.

FIG. 2 is a flowchart showing process performed by a robot controller according to one embodiment.

FIG. 3A is a graph showing second time-series data obtained in accordance with a first example.

FIG. 3B is a graph showing first time-series data obtained in accordance with the first example.

FIG. 4A is a graph showing second time-series data obtained in accordance with a second example.

FIG. 4B is a graph showing first time-series data obtained in accordance with the second example.

FIG. 5A is a graph showing second time-series data obtained in accordance with a third example.

FIG. 5B is a graph showing first time-series data obtained in accordance with the third example.

### DETAILED DESCRIPTION

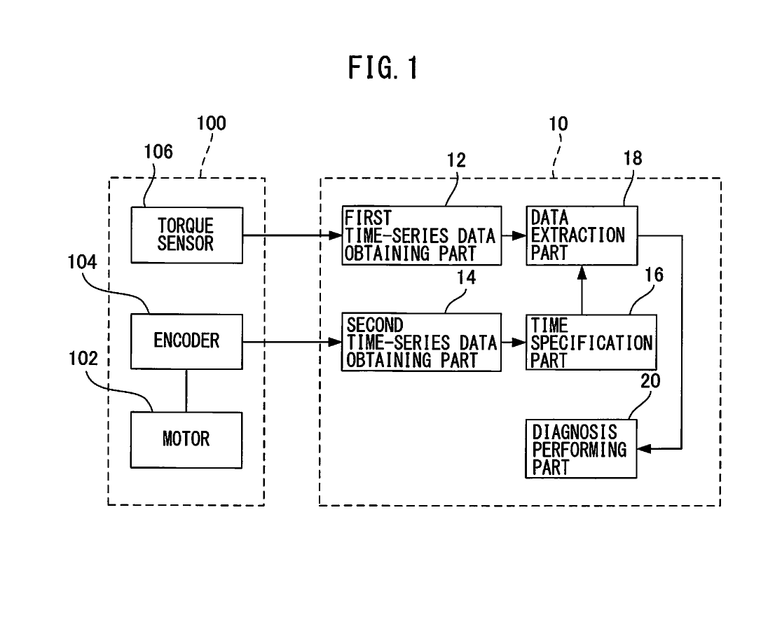

Embodiments of the present invention will be described with reference to the accompanying drawings. FIG. 1 is a functional block diagram of a robot controller 10 according to one embodiment. The robot controller 10 is used to control a robot 100 for desired operation. The robot 100 is not illustrated in detail, but may be a multiple-joint robot provided with a plurality of motors 102 for driving joints.

The robot 100 also includes an encoder 104 for detecting operating information of each of the motors 102, such as an angular position, velocity and acceleration, and a torque sensor 106 attached to the robot 100 for detecting torque acting on each joint axis of the robot 100. The robot 100 is an industrial robot designed to perform processes, such as machining or conveyance of workpieces.

The robot controller 10 is a digital computer having a known hardware configuration including a CPU, ROM, RAM, volatile memory and the like. The robot controller 10 also includes an interface designed to transmit/receive data and signals to/from external devices, and may be connected to an input device, display device or external memory device, as necessary.

As illustrated, the robot controller 10 includes a first time-series data obtaining part 12, a second time-series data obtaining part 14, a time specification part 16, a data extraction part 18, and a diagnosis performing part 20. The robot controller 10 has function of performing fault diagnosis of the robot 100.

The first time-series data obtaining part 12 obtains first data in time series and stores it as a first time-series data in a non-volatile memory or external memory device. The first time-series data is used for fault diagnosis of the robot 100.

The second time-series data obtaining part 14 obtains second data in time series and stores it as a second time-series data in a non-volatile memory or external memory device. The second time-series data is used for extracting the first data which is used for fault diagnosis of the robot 100.

The first data and the second data may be detected by the encoder 104 or the torque sensor 106, or may be obtained by calculation using detected values of these sensors. Alternatively, the first data and the second data may be command values to the robot 100 which are calculated by robot software in accordance with an operation program of the robot 100. The robot software is software for controlling operation of the robot 100. In the case where the first data and second data are obtained by calculation, the first data and second data may be stored successively as the calculation is performed as necessary. Alternatively, the first data and second data may be calculated later at a given time using the information necessary for the calculation, which is stored in advance.

The time specification part 16 specifies extraction time of the first data used for fault diagnosis of the robot 100, based on the second time-series data obtained by the second time-series data obtaining part 14. The time specification part 16 specifies the time of obtaining the second data when the second time-series data satisfies a certain condition.

The data extraction part 18 extracts first data, which corresponds to the extraction time specified by the time specification part 16, from the first time-series data. The extraction data extracted by the data extraction part 18 is read out by the diagnosis performing part 20.

The diagnosis performing part 20 performs the fault diagnosis of the robot 100 based on the first data extracted by the data extraction part 18. Although not illustrated, the robot controller 10 may be configured to give an operator an alarm when the diagnosis performing part 20 determines the fault of the robot 100. The alarm may be given through a warning message on a display device of the robot controller 10 or through an alarm sound, or the like.

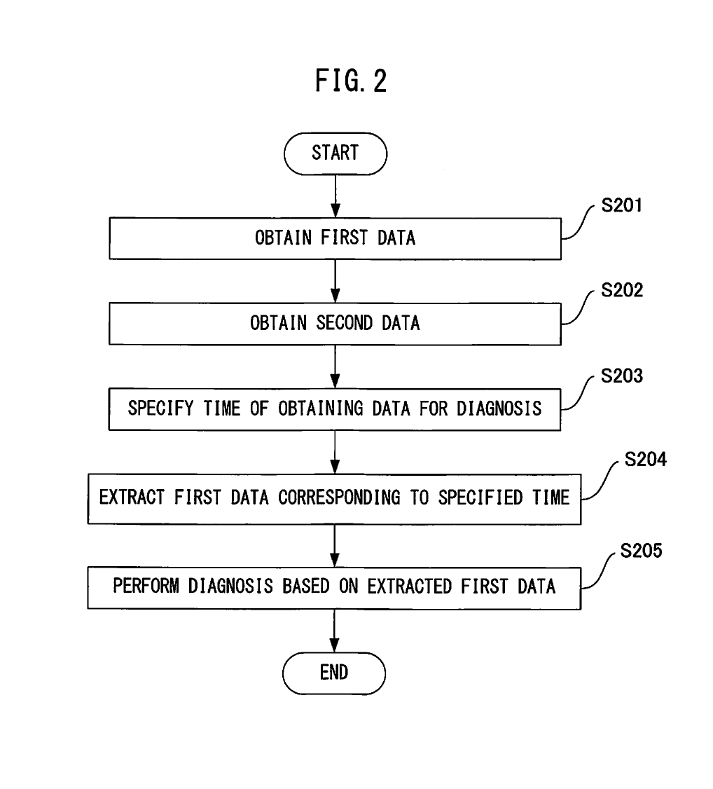

FIG. 2 is a flowchart of the process carried out by a robot controller 10 according to one embodiment. At step S201, the first time-series data obtaining part 12 obtains the first time-series data, which is used for the fault diagnosis of the robot 100.

At step S202, the second time-series data obtaining part 14 obtains the second time-series data, which is used for specifying the extraction time of the first data. The first time-series data and the second time-series data may be obtained in a synchronized manner, but the present invention is not limited thereto. For example, the second time-series data may be obtained by a cycle equal to an integral multiple of the sampling cycle for which the first time-series data is obtained.

At step S203, the time specification part 16 specifies the extraction time corresponding to the first data useful to perform the fault diagnosis, based on the second time-series data obtained at step S202.

At step S204, the data extraction part 18 extracts the first data, which is obtained at the extraction time specified at step S203, from the first time-series data.

At step S205, the diagnosis performing part 20 performs the fault diagnosis of the robot 100 based on the extracted data extracted at step S204. The method of the fault diagnosis of the robot 100 can be determined depending on the type of the first data. According to one embodiment, the fault diagnosis is carried out by comparing reference data prepared in advance with the extracted data. According to another embodiment, the fault diagnosis is carried out by comparing the regular data obtained when the robot properly operates with the extracted data. The processes at steps S203 to S205 may be carried out immediately after the first time-series data and the second time-series data are obtained, or later at any given time.

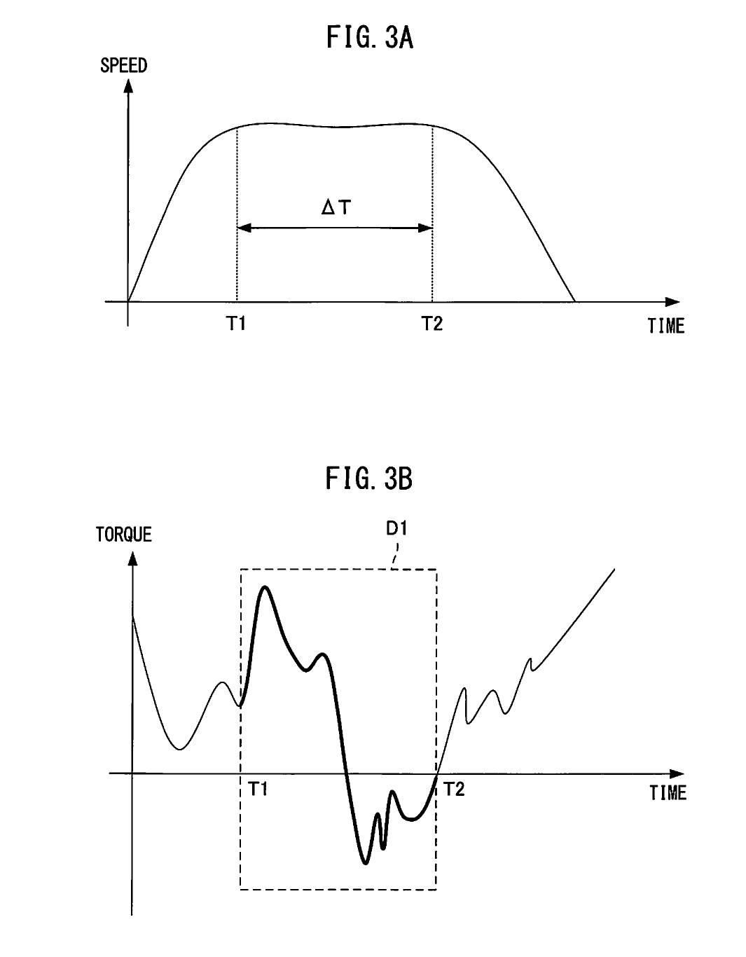

FIGS. 3A and 3B show the second time-series data and the first time-series data obtained according to a first example, respectively. In this example, the first data is torque obtained by the torque sensor 106, and the second data is speed calculated from the detection value of the encoder 104.

The time specification part 16 specifies the time during which the second data or the speed remains constant for a time period longer than a predetermined time period, or specifically, the time from T1 to T2, as the extraction time ΔT. For example, when the deferential of the speed, which is found from the detection values of the encoder 104, is smaller than a predetermined threshold value for a time period longer than a predetermined time period, it is determined that the speed remains constant. The speed here may be a rotational speed of the motor output, or a rotational speed of the axis, or a rotational speed of a rotatable element provided between the motor and the axis.

According to a modification of the present embodiment, the time specification part 16 may also require a condition in which the speed or an absolute value of the speed is within a certain range in order to specify the extraction time ΔT, in addition to the condition being constant. In this case, the above range may not have one of an upper limit value and a lower limit value.

The data extraction part 18 extracts the first data corresponding to the extraction time ΔT. Referring to FIG. 3B, the extraction data D1 corresponding to the extraction time ΔT is illustrated by a heavy line. If the sampling times for obtaining the first data and the second data are not the same and the time of obtaining the respective data are not the same, the first data obtained during a time period between time of obtaining the first data closest to time T1 and time of obtaining the first data closest to time T2 is extracted as the extraction data D1.

The diagnosis performing part 20 performs the fault diagnosis of the robot 100 by carrying out a frequency analysis of the extraction data D1. The frequency analysis may be performed in accordance with a known method such as FFT (Fast Fourier Transform). According to one embodiment, the fault diagnosis may be performed by comparing the result of the frequency analysis with predetermined reference data. Alternatively, the fault diagnosis may also be performed by comparing the result of the frequency analysis with the regular data which is obtained when the robot properly operates.

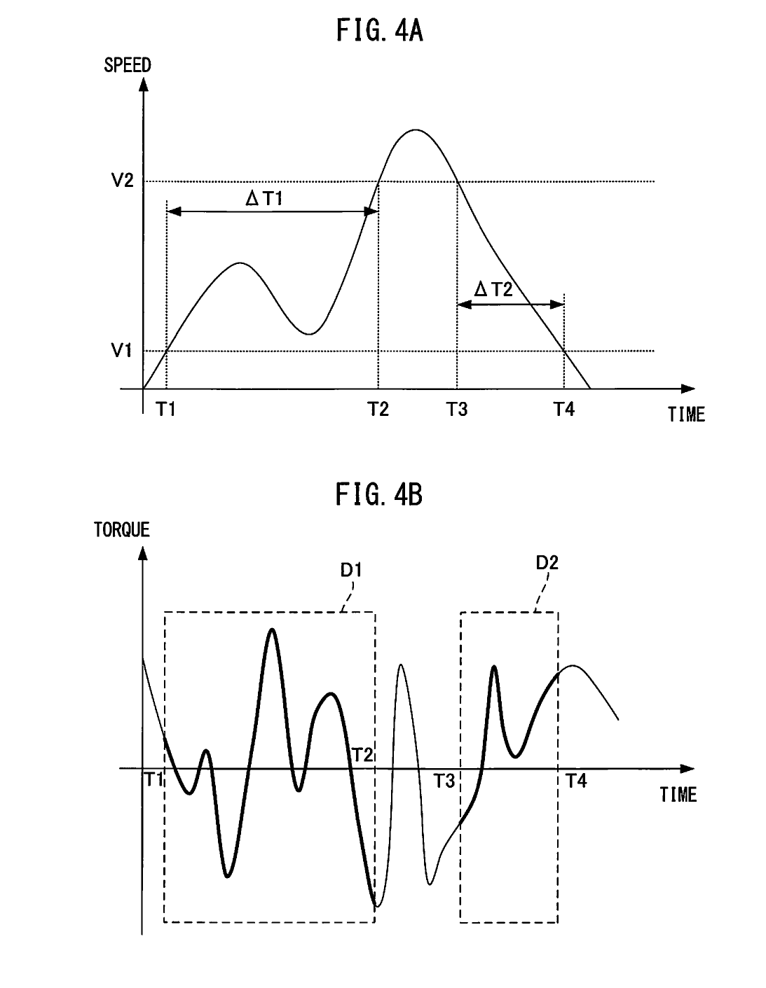

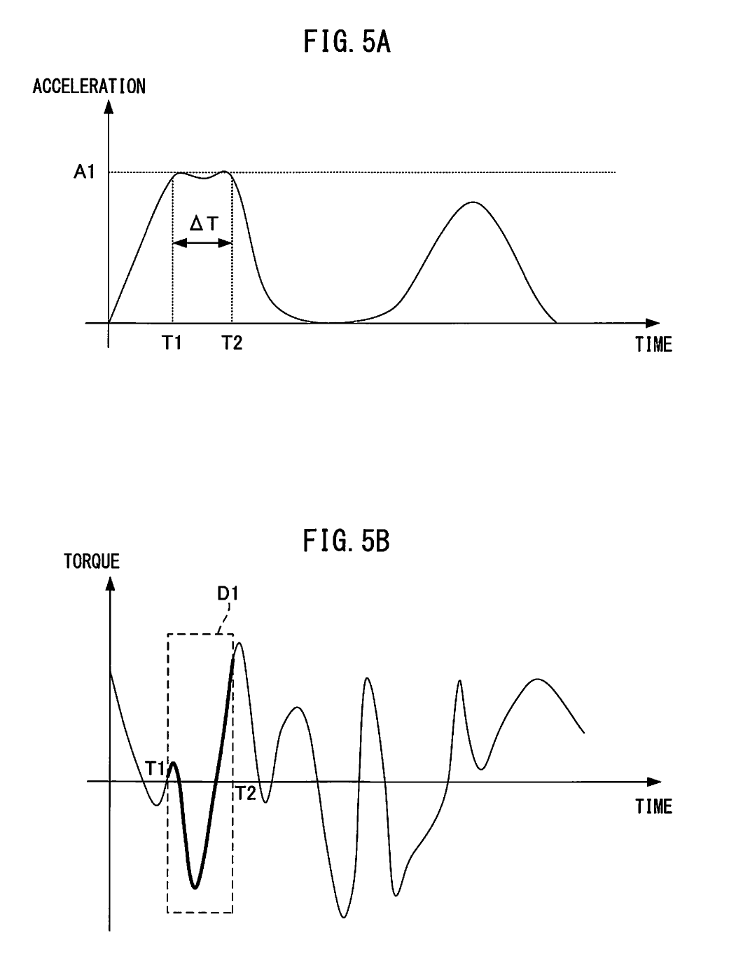

FIGS. 4A and 4B show the second time-series data and the first time-series data obtained according to a second example, respectively. In this example, the first data is torque and the second data is speed as in the first example. However, according to this example, the time specification part 16 specifies the time during which the speed is within a range between speeds V1 and V2, specifically, the time period from T1 to T2 and the time period from T3 to T4 as the extraction time ΔT1 and ΔT2, respectively.

Referring to FIG. 4B, the extraction data D1 and D2 corresponding to the extraction time ΔT1 and ΔT2 are illustrated by heavy lines, respectively. The diagnosis performing part 20 performs the frequency analysis of the extraction data D1 and D2. According to one embodiment, the fault diagnosis may be performed by comparing the result of the analysis with predetermined data. Alternatively, the fault diagnosis may also be performed by comparing the result of the analysis with the regular data which is obtained when the robot properly operates.

According to a modification of the present embodiment, the extraction time ΔT may be specified when the absolute value of the speed is within a certain range. In this case, the range may not have one of an upper limit value and a lower limit value.

FIGS. 6A and 6B show the second time-series data and the first time-series data obtained according to a third example, respectively. According to this example, the first data is torque obtained by the torque sensor 106, and the second data is acceleration calculated from the detection value of the encoder 104. The time specification part 16 specifies a time period for which the acceleration is equal to a certain amount of acceleration A1 for a time period longer than a predetermined time period, or a time period from time T1 to time T2, as the extraction time ΔT. Whether or not the acceleration is equal to the amount of acceleration A1 is determined based on whether or not the acceleration is within a predetermined margin of errors from the amount of acceleration A1. The acceleration may be acceleration of the motor output, acceleration of rotation of the axis, or acceleration of rotation of a rotatable element provided between the motor and the axis.

Referring to FIG. 6B, a heavy line represents the extraction data D1 corresponding to the extraction time ΔT. The diagnosis performing part 20 performs the fault diagnosis of the robot 100 by comparing the magnitude of the torque contained in the extraction data D1 with predetermined reference data. Alternatively, the fault diagnosis may also be performed by comparing the extraction data D1 with the regular data obtained when the robot 100 properly operates.

According to the present embodiment, the reference data used by the diagnosis performing part 20 for the purpose of the fault diagnosis can be preset data which is prepared before the shipment of the robot controller 10, thus eliminating a need for a user to set up the robot controller 100 in a preparatory state in order to perform the fault diagnosis of the robot 100. In addition, the robot controller 10 can perform the fault diagnosis of the robot 100 while the robot 100 accordingly operates in a production process, thus eliminating a need to interrupt the production line for the fault diagnosis. According to the present embodiment, therefore, the fault of the robot 100 can be discovered soon, without affecting the productivity.

According to a modification, disturbance torque calculated by robot software or a torque command to the motor 102 may also be used as the first data, without using the torque sensor 106. In another modification, a speed command or acceleration command to the motor 102 calculated by robot software may also be used, instead of the second data obtained from the detection value of the encoder 104. It should be noted that the first data and the second data are not limited to the type of data explicitly described herein by way of example. For example, according to one embodiment, the first time-series data and the second time-series data may be the same time-series data.

### EFFECT OF THE INVENTION

According to a robot controller of the present invention, it is unnecessary for a user to prepare in advance a reference data used for fault diagnosis and allows fault diagnosis to be performed without interrupting the production process. This makes it possible to detect the fault of the robot early, without sacrificing the production efficiency.

Although various embodiments and variants of the present invention have been described above, it is apparent to a person skilled in the art that the intended functions and effects can also be realized by other embodiments and variants. In particular, it is possible to omit or replace a constituent element of the embodiments and variants, or additionally provide a known means, without departing from the scope of the present invention. Further, it is apparent for a person skilled in the art that the present invention can be implemented by any combination of features of the embodiments either explicitly or implicitly disclosed herein.

What is claimed is:

1. A robot controller capable of performing fault diagnosis of a robot, the robot controller comprising:
a first time-series data obtaining part configured to obtain first data used for the fault diagnosis in time series and store the first data as first time-series data;
a second time-series data obtaining part configured to obtain second data used for extraction of the first data which is used for the fault diagnosis in time series and store the second data as second time-series data;
a time specification part configured to specify extraction time of the first data used for the fault diagnosis, based on the second time-series data;
a data extraction part configured to extract the first data corresponding to the extraction time specified by the time specification part, from the first time-series data; and
a diagnosis performing part configured to perform the fault diagnosis of the robot based on the first data extracted by the data extraction part.

2. The robot controller according to claim 1, wherein the second data is speed information calculated from encoder output.

3. The robot controller according to claim 1, wherein the second data is a speed command calculated by robot software.

4. The robot controller according to claim 1, wherein the second data is acceleration information calculated from encoder output.

5. The robot controller according to claim 1, wherein the second data is an acceleration command calculated by robot software.

6. The robot controller according to claim 1, wherein the first data is torque obtained by a torque sensor attached to the robot.

7. The robot controller according to claim 1, wherein the first data is a torque command calculated by robot software.

8. The robot controller according to claim 1, wherein the first data is disturbance torque calculated by robot software.

9. The robot controller according to claim 1, wherein the time specification part is configured to specify a time period during which speed of the robot remains constant as the extraction time, and wherein the diagnosis performing part is configured to perform the fault diagnosis of the robot in accordance with a frequency analysis of the first data extracted.

10. The robot controller according to claim 1, wherein the time specification part is configured to specify a time period during which speed of the robot is within a certain range as the extraction time, and wherein the diagnosis performing part is configured to perform the fault diagnosis of the robot in accordance with a frequency analysis of the first data extracted.

11. The robot controller according to claim 1, wherein the first data is torque generated in the torque, wherein the time specification part is configured to specify a time period during which acceleration of the robot is a certain amount as the extraction time, and wherein the diagnosis performing part is configured to perform the fault diagnosis of the robot based on the torque.

12. The robot controller according to claim 1, wherein the first time-series data and the second time-series data are the same time-series data.
